(19) United States
(12) Patent Application Publication
(10) Pub. No.: US 2014/0239078 A1
(43) Pub. Date: Aug. 28, 2014

(54) Thermostat Control System with IR Sensor

(71) Applicant: Mitch Altman, Simi Valley, CA (US)

(72) Inventors: Scott Sharitz, Acton, CA (US); Paul Ulman, Woodland Hills, CA (US)

(73) Assignee: Mitch Altman, Simi Valley, CA (US)

(21) Appl. No.: 14/192,676

(22) Filed: Feb. 27, 2014

Related U.S. Application Data
(60) Provisional application No. 61/770,943, filed on Feb. 28, 2013.

(51) Int. Cl. G05D 23/27

(52) U.S. Cl. CPC G05D 23/27
USPC 236/1 C

(57) ABSTRACT

A thermostat control system is suitable for mounting within a substantially sealed housing, and comprises an infrared sensor within the substantially sealed housing that monitors the interior surface temperature of at least a portion of a housing wall. The monitored portion of the interior wall, as well as the thermal path between the monitored wall portion and an exterior housing surface is highly thermally conductive to minimize the lag between temperature changes exterior to the housing and the consequential monitored temperature changes of the interior wall surface. The monitored portion of the interior wall surface is also characterized by high emissivity. Because the interior of the housing is substantially sealed from the external steam bath environment, electronic components within the housing, including the sensor, are protected from the moist environment of a steam bath or other submersible environment.

### FIELD OF THE INVENTION

Steam baths conventionally comprise a steam generator, a steam-dispensing head within a steam bath enclosure that can be occupied by one or more users, and a thermostat control system responsive to the temperature of the steam bath environment within the enclosure to maintain a desired temperature therein by selectively activating and deactivating and/or verifying the generation of steam.

The thermostat control systems of early steam baths used thermostats comprising a bimetallic switching element configured to open and close an electric circuit to respectively de-energize and energize a steam in response to temperature changes within the enclosure. The bimetallic element typically comprised two metal strips of different thermal coefficients of expansion that were sandwiched together. Because the thermal coefficients of expansion of the two metals were different from each other, the bimetallic element flexed as the temperature changed, thereby engaging and moving away from an electrical contact with which it completed the circuit.

More recently, electronic thermostats have been used which comprise a microcontroller responsive to an input value from a thermistor to measure and control the steam bath enclosure's temperature. A thermistor is a resistor that undergoes a change in electrical resistance in response to a change in temperature. The microcontroller essentially monitors the electrical resistance of the thermistor and converts the resistance value to a temperature reading.

Such control systems, however, typically resulted in significant temperature overshoots beyond the desired temperature when heating the enclosed steam bath environment, followed by fall-offs in temperature to a point substantially below the desired temperature. In addition to energy inefficiencies arising from such a hysteresis, which is a consequence of thermal lags described below, the comfort of the steam bath occupant(s) can be adversely affected by temperatures that are lower and then higher than the desired temperature.

Because the heat and humidity within an enclosed steam bath environment is not conducive to long life expectancy and reliability of components forming the steam bath's thermostat control system, it is preferable the temperature sensor and other associated temperature-control circuitry within a sealed housing in the enclosed steam bath environment I in order to prevent the hot moisture from degrading the life and performance of the housed components.

We have noted that the sealing of the temperature sensor within the sealed housing, however, introduces another source of hysteresis owing to the time lag between temperature changes within the steam bath enclosure and the consequential temperature change in sensed air temperature within the sealed housing. Thus, the steam bath environment will continue to heat beyond the desired temperature until the air within the sealed housing reaches the desired operating temperature, and will then continue to cool below the lower temperature limit until the air within the sealed housing reaches the lower temperature limit.

### SUMMARY

In accordance with the invention, a thermostat control system in accordance with the invention is suitable for mounting within a substantially sealed housing, and comprises an infrared sensor within the substantially sealed housing that monitors the interior surface temperature of at least a portion of a housing wall. The monitored portion of the interior wall, as well as the thermal path between the monitored wall portion and an exterior housing surface is highly thermally conductive to minimize the lag between temperature changes exterior to the housing and the consequential monitored temperature changes of the interior wall surface. The monitored portion of the interior wall surface is also characterized by high emissivity. Because the interior of the housing is substantially sealed from the external steam bath environment, electronic components within the housing, including the sensor, are protected from the moist environment of the steam bath.

Those of ordinary skill in the art will recognize that the thermostat control system described herein has applications beyond use with a steam bath in that it is a digital solution for sensing in virtually any emerged environment, from dry to damp to submerged, and at practically any temperature. For example, it can be used to maintain the desired temperature of swimming pool water, of air heated/cooled by HVAC systems, of chemical plant production systems, etc.

These and other details concerning the invention will be apparent from the following description of the preferred embodiment, of which the drawings form a part.

### DETAILED DESCRIPTION OF THE DRAWING

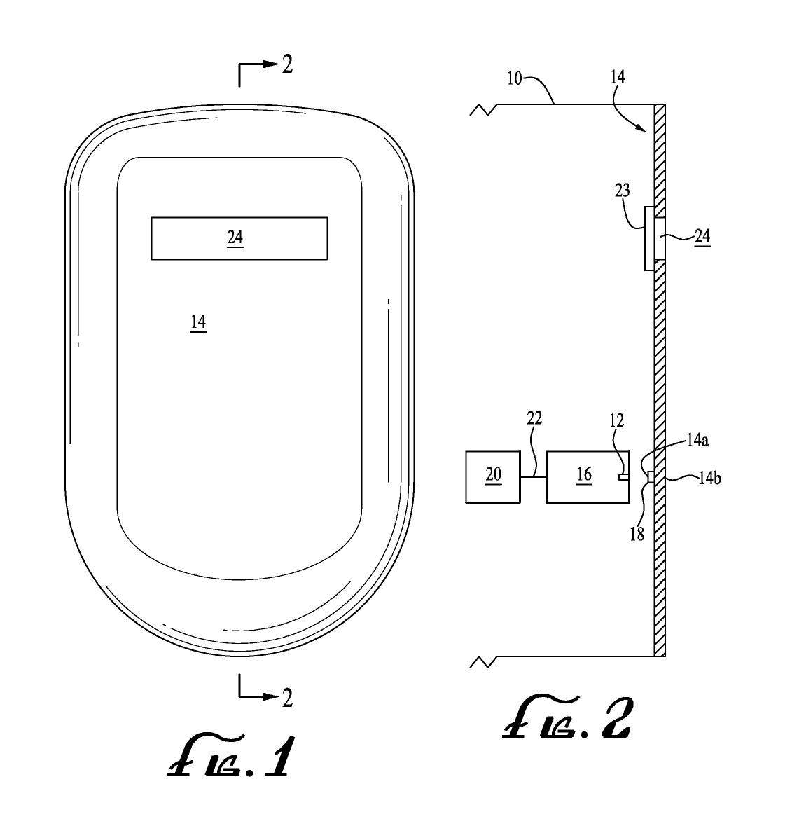

FIG. 1 is a front elevation view of front of a preferred housing for enclosing the temperature sensor of a steam bath temperature control system in accordance with the invention; and

FIG. 2 is a longitudinal sectional view in schematic of the front wall in FIG. 1, taken along line 2-2 therein, illustrating preferred temperature sensing system therein in accordance with the invention.

### DESCRIPTION OF PREFERRED EMBODIMENT

Referring to the FIGS. 1 and 2, an infrared sensor 12 is positioned behind a wall 14 of a housing 10 to be installed within a steam bath enclosure. Once the housing is installed, the sensor 12 monitors the temperature of the enclosed steam bath environment as part of a temperature sensing system 16. Some or all of the remaining electrical components of the temperature sensing system can be mounted within the housing, and/or outside the steam bath enclosure as is known in the art. The temperature sensing system maintains the environment within the steam bath enclosure at a temperature selected by the user by controlling a valve that brings water in a steam generator to a boil so that the resulting steam is channeled to one or more outlets within the steam bath enclosure. The steam bath enclosure is thereby filled with the hot moisture until the desired temperature is reached, and thermostatically held at or close to that temperature thereafter by the temperature sensing unit.

The housing containing the sensor 12 is sealed to protect the components therein from contact with the hot moist environment of the steam bath enclosure following installation. The currently preferred temperature sensing system 16 is the Texas Instruments TMP006, a non-contact infrared (IR) sensor with a digital interface. In accordance with the invention, the infrared sensor is positioned within the housing to sense the temperature of at least a portion 14a of the wall 14's interior surface. The wall 14, or at least a segment lying between the sensed interior portion 14a and an exterior region 14b of the wall, is accordingly formed from a material such as aluminum that is sufficiently thermally conductive and sufficiently thin to minimize the lag time between a temperature change experienced by the exterior surface of the housing wall at 14b and the consequential temperature change experienced by the sensed interior surface 14a.

Preferably, the sensed interior wall surface 14a is formed from a material that is characterized by a suitably high emissivity, which is the relative ability of the surface to emit sensed radiation compared to a “black body” at the same temperature. Emissivity is conventionally represented by the dimensionless constant “ε” (or “e”). A true “black body” is characterized by ε=1. The preferred value of the sensed surface 14a at the time of this filing is characterized by ε>0.9 although lesser values can be considered as well.

A single cost-effective material having the preferred thermal conductivity and the preferred level of emissivity is difficult to identify for use in a steam bath environment. Accordingly, it is presently desired to provide a suitably emissive material to the monitored internal surface portion of the thermally-conductive wall material. This is currently accomplished as a thin overlay of material 18 that is highly thermally-emissive material in the IR spectrum that so that the housing material can be chosen for suitably high thermal conductivity while the overlay provides the desirable degree of emissivity.

The overlay 18 is accordingly affixed, painted onto, or otherwise adhered to the sensed region of the internal wall so that its infrared emissions can be sensed by the infrared sensor as heat from the housing's exterior is quickly conducted to the sensed interior wall surface. A plastic material having the foregoing emissivity is currently preferred, although other materials may be more suitable for other environments and/or temperatures. For example, a glass substrate, instead of plastic, with its backside painted flat black could sense 1000° F. or more with the sensor spaced far enough away to avoid damage from the heat.

Monitoring the IR emissions from the interior surface eliminates the time lag arising from the conventional measuring of air temperature within the housing. The lagging rise or cooling of the air temperature within the sealed housing is essentially eliminated as a variable by monitoring the IR emissions created by heat energy thermally conducted through the housing wall. Because the infrared sensor is located within the housing, it does not protrude through the housing wall to monitor the steam bath environment, and does accordingly not require separated sealing. Further, it is not exposed to the hot moist air of the steam bath environment, and its life is accordingly not shortened by exposure to that environment.

Sensing the interior wall portion also isolates the infrared sensor from a number of external variables that could introduce inaccuracies and consequential control error. For example, the positioning of steam inlets and vents in the steam bath can create relative hot spots and cold spots within the steam bath enclosure that are not predicable, especially prior to installation. Monitoring the internal wall of the housing, however, ensures that the infrared sensor is not mounted in a manner that monitors a hot spot or a cold spot to the user's discomfort, and further ensures that the desired temperature set by the user will essentially result in that temperature from installation to installation because the foregoing installation variables have been essentially eliminated.

Additionally, monitoring the internal housing wall portion ensures that the emissivity of the sensed surface remains constant regardless of transitory variables occurring externally of the housing and within the steam bath enclosure. If the infrared sensor is positioned to monitor a surface lying outside the housing, for example, it might be sensing the surface temperature of an unintended person or object within the monitored region of the steam bath. The sensed person or object may be transitory or temporarily occupying the sensed region. Its surface temperature and emissivity are likely not equivalent to that which is supposed to be monitored, resulting in an erroneous input to the temperature control system and consequential overheating or under heating with accompanying discomfort to the user and energy inefficiency. A person's skin, for example, is controlled to a great extent by biological mechanisms, and its temperature is not likely to be equivalent to that of the steam bath environment. An object may be brought into the steam bath enclosure and, due to thermal inertia, may be at a lower temperature than the environment for a period of time. Both the person and the object are characterized by a different emissivity than the expected value for which the temperature control system was designed. All of these can cause the temperature control system to incorrectly interpret the ambient temperature; these variables are eliminated by sensing the internal wall of the housing, thereby maximizing both the user's comfort and energy efficiency.

The IR sensor communicates with a microcontroller 20, preferably the Atmel AT90CAN32 microcontroller. Communication is preferably via an I2C bus 22 requiring 2 wire communications. This eliminates any voltage drop over the connectivity medium that allows the micro controller to process the digital reading accurately. Standard I2C protocol pull up resistors are placed to maintain speeds of up to 400 KHz. All components are running off an on-board 3.3V regulator that is down-converting from a supplied 5V DC regulated input.

In the illustrated embodiment, a single IR sensor is described and illustrated. However, it should be noted that up to 8 IR sensors can be connected without difficulty in parallel to the same micro controller bus if further sensing areas are required.

The micro controller is initially reset and establishes the sampling rate and bus speeds. Then subsequently—preferably once per second—it processes two 16 bit reads; the first 16 bit read it receives pertains to the temperature of the internal die within the sensor device, while the second reading is a junction voltage that represents that amount of infra red emission from the sensed region of the housing's interior wall that is sensed by the sensor.

The first read is utilized to compensate for ambient temperature changes within the structure of the sensor; i.e., to differentiate between IR energy associated with conducted heat and radiated IR energy. As explained in the TMP006 User's Guide SBOU107 published by Texas Instruments, a TMP006 mounted on a printed circuit board (“PCB”), is as susceptible to conducted and radiant IR energy from below the TMP006 as it is to the IR energy from objects in the sensor's forward-looking field of view. When the area of PCB below the TMP006 is at the same temperature as the die or substrate of the TMP006, heat is not transferred between the IR sensor and the PCB. However, temperature changes on a closely-placed target object (such as the sensed position of the internal wall) or other events that lead to changes in system temperature can cause the PCB temperature and the TMP006 temperature to drift apart from each other. This drift in temperatures can cause a heat transfer between the IR sensor and the PCB to occur. Because of the small distance between the PCB and the bottom of the sensor, this heat energy will be conducted (as opposed to radiated) through the thin layer of air between the IR sensor and the PCB below it. This heat conduction causes offsets in the IR sensor voltage readings and ultimately leads to temperature calculation errors.

Thus, data from the first read is used to offset data from the second read to compensate for such temperature calculation errors using a software algorithm that is a component of the TMP006 to perform a calculation once per second to derive the temperature of the internal wall's sensed portion.

In the preferred embodiment, the micro controller controls a display 23 visible through a sealed window 24 in a housing wall to display the calculated temperature in either Fahrenheit or Celsius degrees, depending on user preference. In addition, the micro controller sends the updated temperature readings to other system components using a control area network protocol bus for other operations including but not limited to steam production, and a voice responsive music system for example.

Although a preferred embodiment of the present invention and its advantages have been described in detail above, it should be understood that various details, changes, substitutions, applications and alterations will be apparent to those of ordinary skill in the art having the benefit of the foregoing specification. It is intended that all such variations be within the scope and spirit of the invention, and that the invention be solely defined by the patent claims appended hereto and given the broadest allowable interpretation consistent with the Doctrine of Equivalents.

We claim:

1. A thermostat control system for a steam bath comprising:
a housing comprising a body enclosed by one or more wall structures extending between respective interior and exterior wall surfaces, said housing enclosing one or more electronic components and being substantially sealed to protect the one or more electronic components from the moist environment of a steam bath,
the one or more electronic components including an infrared sensor positioned within the housing to detect infrared radiation emitted from a sensed region of an interior wall surface,
the sensed region of the interior wall region being thermally coupled to an exterior wall surface via thermally-conductive material that defines a thermal path from the exterior of the housing to the sensed region so a temperature change experienced by the exterior surface of the housing,
the sensed region further including a layer of high emissivity material thermally coupled to the interior wall surface in such a way that its emissivity is affected by the thermal energy conducted from the exterior surface of the housing to the sensed region.

2. The system of claim 1 wherein the thermally conductive material is substantially aluminum.

3. The system of claim 1 wherein the emissivity (s) of the high emissivity material is substantially 0.9.

4. The system of claim 3 wherein the overlay is affixed, painted onto or adhered to the thermally conductive material.

5. The system of claim 4 wherein the overlay is formed from a highly emissive plastic.

6. The system of claim 4 wherein the overlay is glass.

7. The system of claim 6 wherein the glass is painted black.

8. The system of claim 7 wherein the glass is painted black on a surface closest to the sensor.
